(19) United States
(12) Patent Application Publication
(10) Pub. No.: US 2018/0313375 A1
(43) Pub. Date: Nov. 1, 2018

(54) HIGH NOSE CLAMP

(71) Applicant: Harcourt Industrial, Inc., Madison Heights, MI (US)

(72) Inventor: Dale Beardmore, Rochester Hills, MI (US)

(21) Appl. No.: 15/968,532

(22) Filed: May 1, 2018

Related U.S. Application Data
(60) Provisional application No. 62/492,796, filed on May 1, 2017.

(51) Int. Cl. F16B 2/18; F16B 2/10

(52) U.S. Cl. CPC F16B 2/18; F16B 2/10

(57) ABSTRACT

A high nose clamp having a base, a handle pivotally mounted to the base and a clamping arm pivotally mounted to the base. Over center links connect the handle and the clamping arm. The over center links can be moved between over center positions and non-over center positions to lock and unlock the clamp. The clamp arm has a first vertical portion and a horizontal portion with the vertical portion having a length in the vertical direction of one inch to five inches.

### RELATED APPLICATIONS

This application claims the benefit of U.S. Provisional Application No. 62/492,796 filed on May 1, 2017, which is incorporated herein by reference in its entirety.

### STATEMENT REGARDING FEDERALLY SPONSORED RESEARCH

NONE.

### TECHNICAL FIELD

This invention relates generally to quick release toggle clamps and in particular to an improved quick release clamp having a high nose.

### BACKGROUND OF THE INVENTION

Quick release toggle clamps are generally used to clamp one object with respect to another. For example, quick release toggle clamps can be used for clamping a template onto a work piece. Typically, the toggle clamp has a mounting base that is mounted adjacent the work surface. A template is then positioned on the work surface and the clamp is engaged to hold the template on the work surface. For larger work surfaces, there are generally a number of clamps positioned about the work piece. The various clamps are placed in spaced locations around the work piece and the quick release allows a worker to clamp and unclamp the toggle clamps quickly.

Toggle clamps typically have a base, a nose or clamp arm which has a clamp screw and a handle to engage and disengage the clamp arm. The handle and clamp arm are pivotally connected to the base and linked to each other such that by moving the handle, the clamp arm engages the piece to be clamped and the handle aligns with the base to restrict movement of the clamp arm.

A problem with known quick release toggle clamps is the clamp arm is straight resulting in limitations on use, the need to mount the base to raised surfaces and in some instances faulty clamping.

### SUMMARY OF THE INVENTION

The present invention overcomes these disadvantages by providing a quick release toggle clamp with a raised nose that can clamp raised surfaces. The toggle clamp of the present invention also maintains the clamp head in alignment with the pivot point of the clamp head for optimal clamping.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a perspective view of the toggle clamp of the present invention.

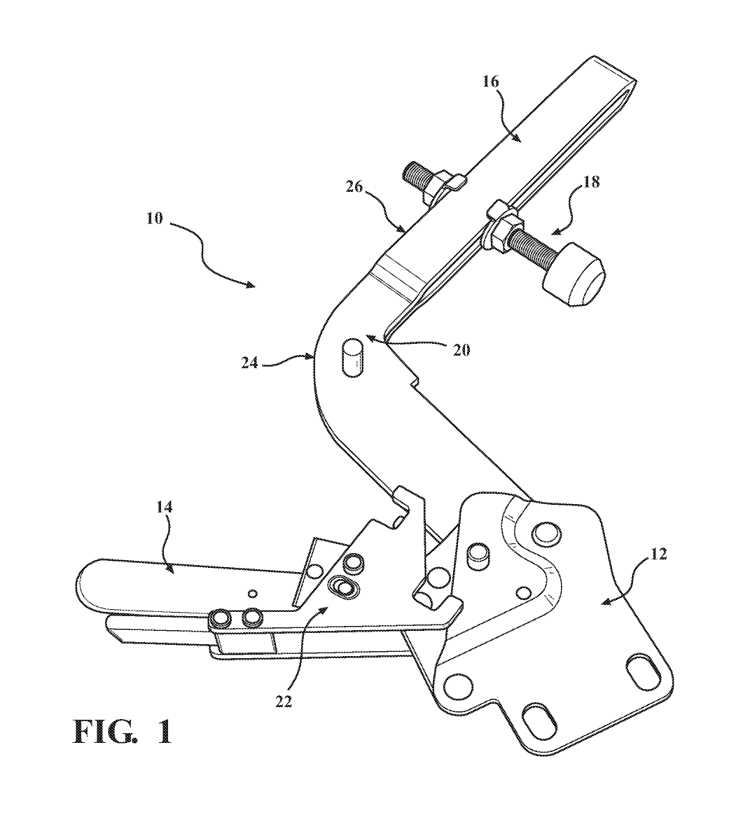

### DETAILED DESCRIPTION OF PREFERRED EMBODIMENT

The high nose clamp of the present invention is shown generally at 10. The high nose clamp 10 has a base 12 which is adapted to be mounted adjacent to a work surface. As will be appreciated by those of ordinary skill in the art various methods can be used to mount the base, including for example, bolts, screws, magnets, permanent welding, etc. The clamp 10 of the present invention is mounted to the work surface with bolts and is generally intended to be permanently mounted in place. Also, by way of example, the present invention would likely include a number of high nose clamps mounted around a workpiece to clamp various items to the workpiece.

The clamp 10 has a handle 14 and a clamping arm 16 pivotally mounted to the base 12. The handle 14 and clamping arm 16 are linked to each other so that movement of the handle 14 results in pivoting of the handle 14 with respect to the base and movement of the arm 16 and pivoting of the arm 16. A clamping head 18 or screw is mounted to the arm 16. The clamping head 18 is mounted within a slot in the clamping arm 16 to allow the head 18 to move along the arm 16 for adjustment with respect to the piece to be clamped.

By raising the handle 14, the arm 16 is forced into the clamping position. Once the head 18 is in alignment with the pivot point of the handle and the handle 14 is generally at a right angle with respect to the longitudinal axis of the base 12, the clamp 10 is clamped to the piece. A slight movement of the handle 14 away from the workpiece will release the clamp head 18 allowing for quick release. The clamp 10 as shown includes an optional lock to lock the arm 16 in the clamped or fully released positions.

The clamp arm 14 of the present invention has a first vertical portion 24 and a second horizontal portion 26. The vertical portion 24 provides the raised nose of the present invention to allow the clamp to be clamped to higher raised surfaces. The vertical portion 24 allows the clamp 10 to be mounted adjacent a work surface without modification of the mounting position to accommodate for the height of the piece to be clamped. In the disclosed embodiment, the vertical portion 24 can have a length of 1 inch to 5 inches.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A high nose clamp comprising:
a base;
a handle pivotally mounted to said base;
a clamping arm pivotally mounted to said base;
over center links connecting said handle and said clamping arm, said over center links being moveable between over center positions and non-over center positions;
movement of said handle moves said arm between the clamped and unclamped positions, said over center links being in the over center position when said handle moves said arm to said clamped position;
said clamp arm having a first vertical portion and a horizontal portion said vertical portion having a length in the vertical direction of one inch to five inches;
a head mounted to said horizontal portion;
said head being movable along said horizontal portion.
